(19) United States
(12) Patent Application Publication
(10) Pub. No.: US 2008/0010114 A1
(43) Pub. Date: Jan. 10, 2008

(54) METHOD AND SYSTEM FOR GENERATING AND REDEEMING AN ELECTRONIC COUPON

(76) Inventor: John R. Head, Austin, TX (US)

Correspondence Address: HULSEY IP INTELLECTUAL PROPERTY LAWYERS, P.C., 919 Congress Avenue, Suite 919, AUSTIN, TX, 78701, US

(21) Appl. No.: 11/423,654

(22) Filed: Jun. 12, 2006

(51) Int. Cl. G06Q 30/00

(52) U.S. Cl. 705/14

(57) ABSTRACT

A method and system for generating and redeeming electronic coupons so as to reduce inefficiencies in coupon distribution and redemption. The system and method provide data gathering and analysis such that the electronic coupon offers may be more effectively designed. The system and method provide for generating an electronic coupon, transferring an electronic coupon to a smart or linking to an ID card, redeeming an electronic coupon at a retail location, and tracking and analyzing user data of redeemed electronic coupons.

### TECHNICAL FIELD

The disclosed subject matter relates generally to a method and system of coupon delivery and redemption. More particularly, this disclosure relates to a novel and improved method and system of electronic coupon delivery and redemption for analyzing consumer spending habits.

### DESCRIPTION OF THE RELATED ART

The most widely used method for coupon delivery and redemption is that of printed, mass-distributed coupons. These coupons are often included in newspaper inserts, mailed directly to a home, or placed in retailer specific catalogs. Newer methods of online distribution have lowered the overall costs involved in the mass distribution method. It is the desire of both the retailers and manufacturer to increase the demand for their product through the coupon delivery method. Another purpose of the coupon is to initiate a product switch in a consumer or increase the volume of sales for a particular product.

The redemption rate for coupons is extremely low. Approximately three percent of all printed coupons are redeemed by consumers yet some methods are less than one percent. The costs relating to delivery and redemption of coupons are in excess of $20 billion per year. These costs consist of handling, generating, and mailing the coupons as well as errors in redeeming the coupons at retail establishments.

Retailers and manufacturers have become cognizant of the fact that the most effective point to influence spending habits of a consumer is at the time is which the consumer makes the product decision; i.e. in-store. Unfortunately, current methods of mass distribution and on-line distribution only target consumers at a point much before they enter a store. The manufacturers and retailers rely on the consumer to remember the coupon offer, remember to take the printed coupon to the store, and redeem the coupon at the store. The mass distributed print coupons are normally designed to last a specified amount of time to reduce total financial exposure to redemption of all coupons distributed. This built in time frame for coupon redemption precludes changing coupon offers on-demand. Thus, if a retailer or manufacturer wishes to change a coupon offer to increase demand for their product there is no method to do so if a previous coupon has a time limit that has not expired.

The collection of coupons for redemption is generally a manual process, in which the coupons are collected at a POS (Point of Sale) terminal, usually by a store clerk, and then amassed in-store at the end of each day. The coupons are then forwarded upon specific schedules to be verified by an independent party. This independent party handles each paper coupon individually, then validates its authenticity to the manufactures. Only at this point may the retailer be reimbursed for the coupon's value. If the coupon is not verified there is an immediate loss. This manual process is cumbersome, has a long lead time and is often riddled with mistakes. Essentially the manual process is extremely inefficient and costly.

Tracking the coupon redemption statistics of consumers is currently limited at best. Tracking these statistics is important to both retailers and manufacturers for many reasons. First tracking statistics can show trends in consumer spending. This can allow manufacturers and retailers to revise the coupon offer for higher efficiency and profit. Location and demographic information may be combined to show trends in consumer spending as well. This also will allow manufacturers and retailers to more effectively target consumers with their coupon offers.

Accordingly, a need exists to improve over the known coupon distribution system and data gathering methods. A further need exists to reduce inefficiencies in the coupon redemption process.

In essence, therefore, a need exists to eliminate the printed coupon process and replace it with a more cost effective and efficient method of coupon generation and redemption.

### SUMMARY OF THE INVENTION

The disclosure here disclosed provides for an efficient method and system of generating and redeeming an electronic coupon. The disclosed subject matter is not only capable of delivering and generating a coupon but also can gather and analyze redemption statistics.

In accordance with the one embodiment of the present disclosure the system consists primarily of a central database, a computer system capable of executing a software product, a series of shelf devices and several redemption devices, located in proximity to a POS terminal.

The software product either automatically or based on a retailer or manufacturer's input instructs the computer to generate an electronic coupon, which is then stored in a database.

The customer may be provided with a smart card capable of storing an electronic coupon and may obtain an electronic coupon at a shelf device. They may also be provided with an ID card capable of providing unique identification.

The shelf device includes means for transferring the electronic coupon to the smart card and a display to show a user's coupon data. Alternatively, the ID card will be used to link the ID to a coupon ID for storage on a DB on our link to the stores systems. After the user has completed shopping the electronic coupon may be redeemed at a redemption device.

The redemption device is capable of receiving data including coupon values, from the smart card or customer ID and retrieving coupon data which is stored in the databases based on that ID. The software product analyzes the customer and coupon data after the redemption of the electronic coupon.

Manufacturers and retailers may then choose to change the electronic coupon offer to more effectively target users. Therefore, the system provides one method of allowing coupon offers to be changed on-demand.

Accordingly, it is an object of the present disclosure to provide a system and method for generating and redeeming electronic coupons that allows analysis of redemption data not previously contemplated in traditional coupon delivery systems. Another object of the present disclosure is to alleviate the inefficiencies in the verification process of coupons by allowing the coupons to be electronically verified. Other objects of the present disclosure will be apparent in light of the description of the disclosure embodied herein.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following figures and detailed description. It is intended that all such additional systems, method, features and advantages that are included within this description, be within the scope of the accompanying claims.

### DESCRIPTION OF THE DRAWINGS

The features, nature, and advantages of the disclosed subject matter will become more apparent from the detailed description set forth below when taken in conjunction with the drawings in which like reference characters identify correspondingly throughout and wherein:

FIG. 1 is a block diagram showing one preferred embodiment of the present disclosure;

FIG. 2 is a block diagram showing one preferred embodiment of the present disclosure;

FIG. 3 is a flow diagram of one embodiment of the present disclosure;

FIG. 4 is simplified block diagram of aspect of the present disclosure;

FIG. 5 is a simplified block diagram of one aspect of the present disclosure;

FIG. 6 presents a block diagram of POS terminal in communication with at least one database;

FIG. 7 is a processes diagram portraying a customer being a smart card to receive an electronic coupon or an ID card to store a coupon in the DB;

FIG. 8 is a processes diagram portraying a customer redeeming an electronic coupon;

FIG. 9 details a flowchart for teaching the implementation of the present disclosure by a retail store; and

FIG. 10 details one implementation of a data path for teaching the use of the method and system of the present disclosure.

### DETAILED DESCRIPTION OF THE SPECIFIC EMBODIMENTS

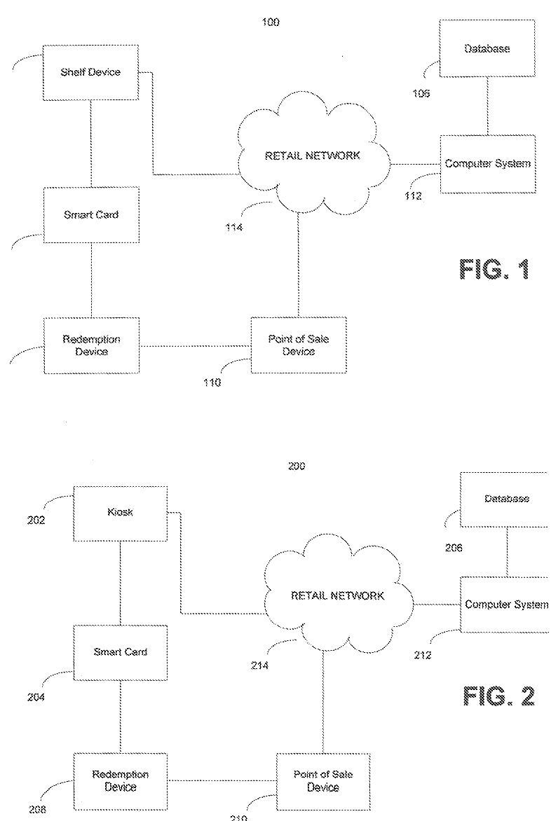

There are various embodiments and configurations for implementing the present disclosure. One such implementation is shown in FIG. 1, where the system 100 includes a computer system 112, database 106, a smart card or ID card 104, a redemption device 108, a shelf device 102, a point of sale (POS) terminal 110, and retail network 114. There may be included a plurality of POS terminals 110. The network 114 is of a well known type, wherein the POS terminal 110 may be located at one or more retail establishments (e.g. grocery stores). The POS terminals may have price look-up and other functionality, either internally or through interconnection to a server or database (not shown) within the retail network 114.

POS devices 110 used for conducting retail and similar transactions are well known. Although not illustrated in FIG. 1, such terminals may include a keyboard, a display and various peripheral devices or functions (e.g., magnetic stripe card readers, optical bar code reader, etc.) well known, to those skilled in the art. As should also be appreciated, the POS terminals may be operated by a retail clerk when products to be purchased are presented by a customer at a checkout line, or could be a self-service terminal used by the customer, without intervention by a retail clerk (e.g., at a checkout station, built into a shopping basket, or located elsewhere within a retail establishment).

When products are taken by a customer to the POS terminal 110, product information is entered (e.g., at a keyboard or through the use of a bar code scanner). Product information is used to retrieve pricing information. The customer may use cash or a financial card (e.g., credit, debit or similar card), and in the case of a card, information may be read at the POS terminal 110 by a magnetic stripe reader of the like.

A retailer or manufacturer may input coupon data to be stored in the database 106. The coupon data may include such information as the amount of the offer, the time period the offer will be available, the store in which the electronic coupon may be redeemed or the individual who may redeem the electronic coupon, and universal product code (UPC) data or product family (UPC) data. A software product (not shown) instructs the computer system to generate the electronic coupon on a shelf device 102. The system 100 may further comprise a plurality of shelf devices.

A smart card 104 may be any device configured to receive an electronic coupon. In one embodiment the smart card 104 is a customer loyalty data as known in the art. In another embodiment the smart card may be contained with a shopping cart. A customer may obtain a smart or ID card 104 in a variety of ways. For example, a customer may obtain a smart or ID card 104 upon entering a retail establishment, via mail or at a kiosk. The card ay be issued after a customer inputs customer identification information either on the Internet, as a kiosk, or in print. The card 104 may be unique to an individual or in the case of a smart or ID card 104 presented at a retail store location, anonymously used.

A customer may obtain a plurality of coupons by presenting the smart or ID card 104 at and one of a plurality of shelf devices 102. The shelf device 102 consists primarily of a means for displaying coupon data, such as a liquid crystal display (LCD) screen or the like, a means for transferring data to a smart card 104, and a power source. The shelf device 102 is configured such that when a smart card 104 is presented an electronic coupon is transferred to the smart card 104. Another embodiment is the use of an ID card 104 where when the ID card 104 is presented to shelf device 102 the ID of the card is linked to the coupon and stored on the DB 106. This may be accomplished by various means known in the art. For example, the shelf device 102 may be configured to read a magnetic stripe contained by the smart card 104. It may also be configured to wirelessly send the electronic coupon to the smart card 104 when the smart card 104 is placed in proximity of the shelf device 102. It may also be configured so the ID card 104 passes its ID to the shelf device 102 wirelessly.

In another embodiment the shelf device 102 may receive customer data to be stored in the database 106 for analysis. This data may include the customer name, demographic information, location of the store, location of the coupon retrieved by the customer within the store, the time of the transaction, and UPC data. In another embodiment the smart card 104 may be preloaded with electronic coupons when obtained by the customer. These electronic coupons may be associated uniquely to the customer, a specific retail store location, a chain of retail stores, or a plurality of retail chains.

The POS terminal 110 shall be configured such that a redemption device 108 is capable of transmitting coupon data to the POS terminal 110. The redemption device 108 is capable of reading the smart or ID card 104 in one of a variety of ways. For example, the redemption device 108 may be configured to read the smart of ID card 104 wirelessly when the card 104 is placed in proximity or via magnetic stripe reader as known in the art.

In the exemplary embodiment the redemption device 108 receives coupon data as well as consumer data from the smart or ID card 104 during redemption. This data may include the customer name, demographic information, location of the store, location of the coupon retrieved by the customer within the store, the time of the transaction, UPC data and the like. This information is stored in the database 106 for analysis. The redemption device 108 then sends the appropriate UPC data to the POS terminal 110 for final checkout. It should be appreciated that the redemption device 108 may be in communication with the POS terminal 110 by means such as a universal serial bus (USB) connection, serial connection or the like and the POS terminal 110 may be configured such to contain the redemption device 108. In one embodiment of the present disclosure the coupon data is verified electronically at the redemption device 108 thereby reducing the need for the cumbersome manual verification process of printed coupons.

The analysis performed by the computer system 112 may reveal data such as redemption trends that will allow manufacturers or retailers the option to more specifically target customers. For example, the data can be analyzed to determine which coupons were retrieved but not redeemed, or which coupons were ignored by the customer. In one embodiment the system 100 allows for changes to the coupon date “on-demand” meaning that the coupon data may be altered at any point in time so that the coupon offer may be more effective in increasing profit to the retailer or manufacturer.

The smart or ID card 104 may be configured to include an RFID (Radio Frequency Identification) tag, such that the location throughout the retail establishment may be tracked and stored in the database 106. In this way the analysis may show the path of a customer throughout a retail establishment in conjunction with electronic coupons that either were or were not obtained.

FIG. 2 portrays a system 200 comprising a computer system 212, database 206, a smart or ID card 204, a redemption device 208, a kiosk 202, a POS terminal 210, and a retail network 214. There may be included a plurality of POS devices 210.

In system 200 a smart card 204 may receive coupon data at a kiosk 202 or an ID card 204 may assign coupons to the ID card in the DB 206. The kiosk 202 may be located within a retail store location or may be a stand-alone device outside of the retail establishment. The kiosk may offer a variety of electronic coupons to a customer to be loaded onto a smart card 204 or linked to an ID card 204. It should be appreciated that any means of communicating with a smart or ID card 204 can be used to load the electronic coupons on the smart card 204 or assign them to the ID card 204, such as conventional wireless technology or a magnetic stripe reader. The kiosk 202 is capable of receiving customer data to save in the database 206 for redemption analysis. This data may include the customer name, demographic information, location of the store, location of the coupon retrieved by the customer within the store, the time of the transaction, and the like. A similar method as described in FIG. 1 may be employed to redeem the electronic coupon.

Stand-alone kiosks 202 may be located within shopping malls or be configured as an automatic teller machine (ATM). In the first instance a shopping mall with a plurality of retail establishments creates a necessity for a centralized place to obtain electronic coupons. In the second example, financial institutions may use their ATM systems in partnership with manufacturers or retailers to provide customers with special coupon offers. In one embodiment of the present disclosure the smart card 204 is a bank ATM, debit card or the like.

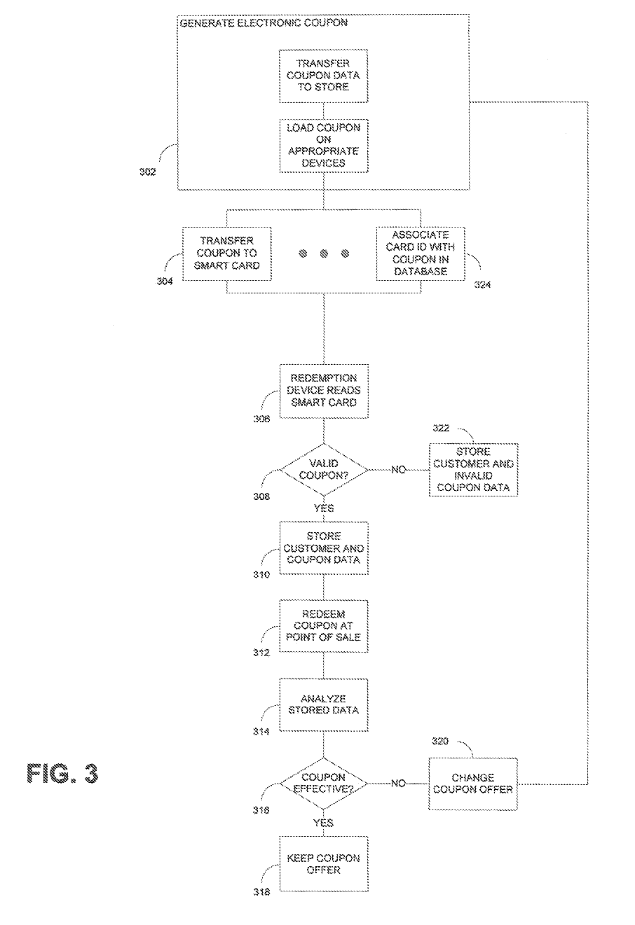

FIG. 3 represents a flow diagram of one embodiment of the present disclosure. First, in step 302 an electronic coupon is generated. This may be accomplished by the manufacturer or retailer entering coupon data into a computer system 112 for storage in a database 106. The electronic coupon may then be transferred to a smart card 104 or assigned to an ID card 104 in the DB in step 304. This step may be facilitated by a shelf device 102 or a kiosk 202. Furthermore, an electronic coupon may be preloaded by the manufacturer, delivered via the Internet or the like. After the customer has completed shopping the smart or ID card 104 may be read by a redemption device 108 as in step 306. Next, the present disclosure may be configured to verify the electronic coupon for validity, step 308. If the coupon is invalid as in step 322 customer and invalid coupon data is stored in a database 106 and the coupon is not redeemed. If the coupon is valid as in step 310 customer and coupon data is stored in the database 106 for later analysis (step 314).

The valid electronic coupon is then redeemed at a POS terminal 110. After a software product completes analysis of the stored coupon data in step 314, a decision is made as to whether the coupon offer is effective in step 316. This may be accomplished through various means, such as preset instructions in a software product, or review of the analysis by a manufacturer or retailer. If the electronic coupon is effective, as in step 318, the offer is not changed. If the electronic coupon is ineffective the electronic coupon may be changed on-demand as in step 320.

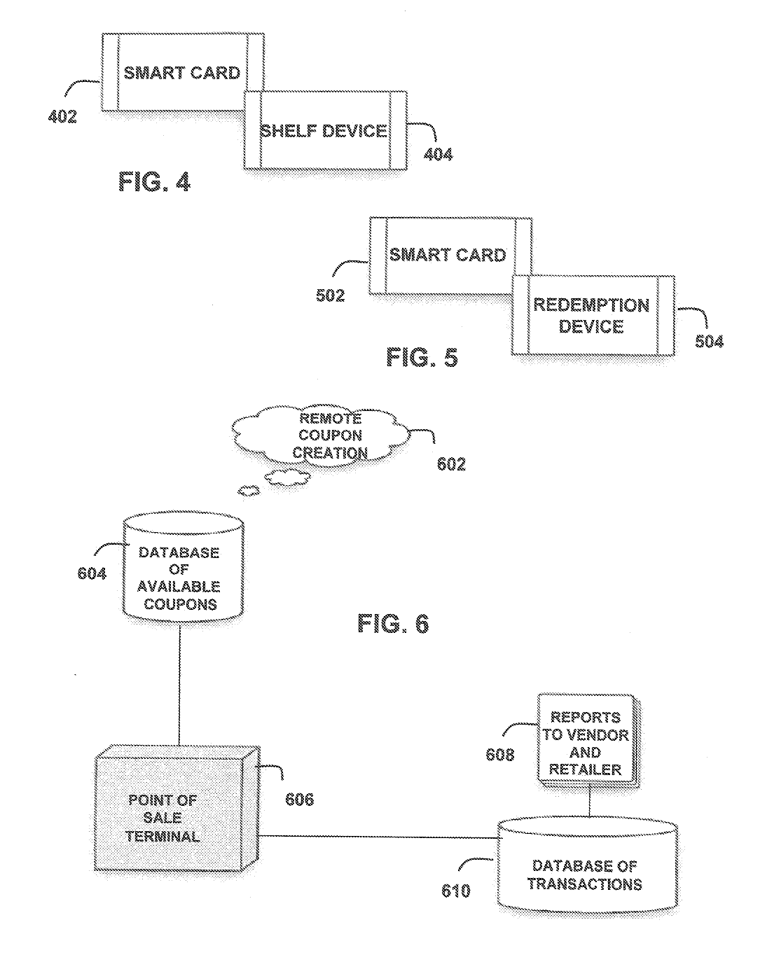

FIG. 4 and FIG. 5 each portray a smart card and another device, which the smart card may communicate with. In FIG. 4, the smart card 402 and the shelf device 404 are detailed. The smart card 402 may be configured such that it has an unique card identification, such as a number, bar code, magnetic stripe or the like. The card 402 may be linked directly to a specific customer such that the customer's information (i.e. name, age, demographics, etc.) may be used by retailers and manufacturers to more accurately target customers for coupon offers. The card 402 may have be associated directly with a retailer and be branded as such (i.e. the card may carry a retail specific logo). In some embodiments the smart card 402 may be any media device capable of sending data or receiving data. In essence a traditional “card” design is not necessary. The card may further be capable of storing the UPC data of coupons or items it accesses.

The shelf device 404 also may be configured to have a unique identification (i.e., a specific internet protocol address, an ID number, or the like). The device 404 is capable of accessing UPC data of coupons either through internet memory, a database 604 as seen in FIG. 6, or the like. The device 404 can be associated with a store and may be capable of delivering or receiving time and date information to or from the card 402. This “time-stamp” may be used in the data analysis process to pinpoint where an opportunity to receive an electronic coupon was taken by a customer. The device 404 may be further capable of being updated via a network through internet or other industry standard or custom protocols. Coupon data, such as the value of the coupon, the item the coupon is associated with, and the duration of the coupon offer may be displayed on the shelf device's 404 LCD or by other display means. Finally, the device 404 may be configured for remote access through means such as Bluetooth® technology, wireless Radio Frequency (RF) communication, Infrared communication (IR) or the like.

FIG. 5 likewise portrays the smart card 502 as described above, and a redemption device 504. The redemption device 504 may have a unique identification and be capable of retrieving electronic coupons stored on the smart card 502 or the ID from the card 502. After receiving all coupon data from the smart card 502 the redemption device 504 transform the data of the coupon to a POS terminal 606 as seen in FIG. 6. In the case of the ID card, it used the ID to retrieve the coupon data associated with the ID from the DB 610 and transfer that coupon data to a POS terminal). The device 504 may also be configured to store the redeemed electronic coupons in a database to for verification purposes. This electronic verification process will accelerate the normal verification process and also remove inefficiencies of human error, such as loss of printed coupons by a store clerk. Finally, the redemption device 504 transfers information such as the time, date, customer data, and location data in a database 610 as seen in FIG. 6 for analysis.

FIG. 6 displays a POS terminal 606 capable of communication with a first database 604 and a second database 610. The POS terminal 606 may access coupon data from the first database 604. When the POS terminal receives the UPC data of individual coupons from the smart card 502 via the redemption device 504 or the coupon data stored by ID card 502, the POS terminal 606 can use the coupon data from the first database 604 to return a value. This allows the POS terminal 606 to correctly issue the coupon offer to a customer.

The first database 604 may contain UPC data of coupons, the valid time period which a coupon is available, the value of a coupon, and the product UPC associated with a coupon. This information may be entered remotely either via internet access or other means by a retailer or manufacturer. This data may be received upon request from a retailer coupon website as is current industry practices.

The second database 610 is capable of storing a plurality or data. This data may include the UPC data of coupons redeemed, the identification of the smart of ID card 502 used at the redemption device 504, the identification of the shelf device 404, the identification of the redemption device 504, the transaction identification, the time and date data, the redemption status of any coupons, the value of any coupons, the applicable product UPC data, and the POS terminal identification that was used to redeem any coupons. It should be appreciated that although the first database 604 and second database 610 are portrayed separately the system may be configured such that the data stored by either database may be contained in one or a plurality of databases.

This data may be gathered over time, analyzed and reports 608 may then be issued. The reports 608 may be specific to a retailer, specific to a manufacturer or general market reports. The reports 608 may include a variety of data concerning customer redemption statistics. These reports 608 are designed to aid retailers and manufacturers to more effectively target customers.

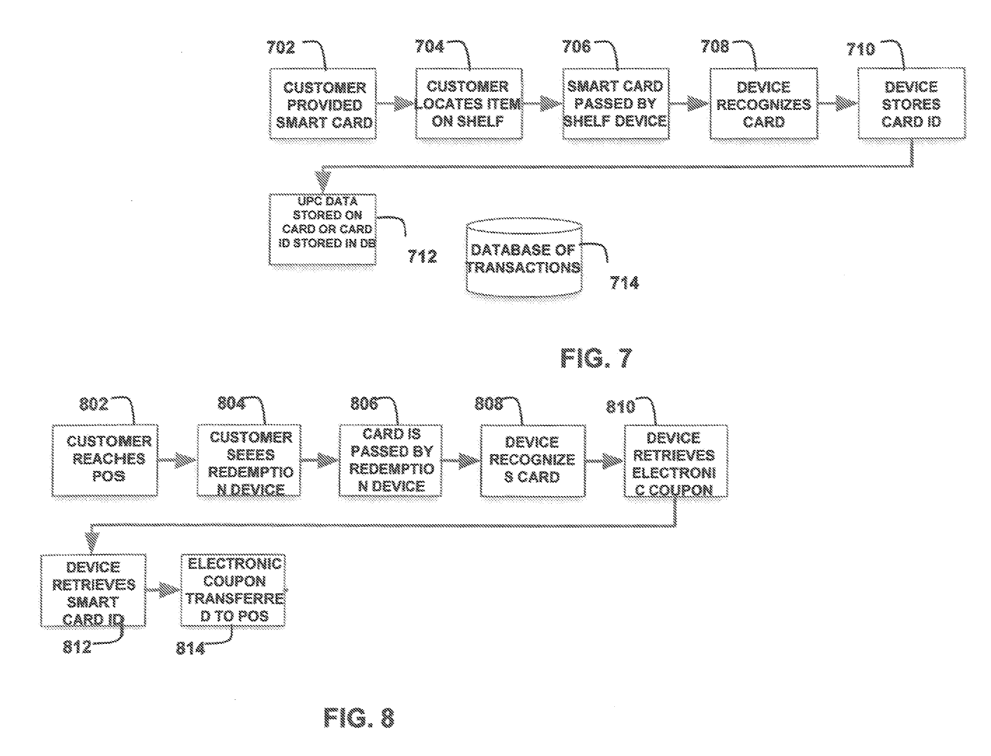

FIG. 7 displays the process in which a customer may use a smart of ID card 402 to retrieve an electronic coupon from a shelf device 404 or store an electronic coupon on the DB 604. First, a customer is provided a smart card 402 in step 702. The card may be provided in a variety of methods, such as via mail from a retailer, via mail from a manufacturer, or upon entering a retail store. Next, in step 704, a shopping customer locates an item with an associated shelf device 404. The customer initiates an electronic coupon transaction in 706 between the shelf device 402 and a smart or ID card 402. This may be accomplished by passing the smart of ID card 402 in close proximity to the shelf device 404 such that the device 404 recognizes the card 402 in step 708. The shelf device 404 receives the smart or ID card's 402 identification and stores the electronic coupon on the smart card 402 in steps 710 and 712, respectively or in the case of the ID card 402 stores coupon requests in DB 614. The transaction data is stored in the database 714 for later analysis and may include such data as the UPC data of the coupon, the identification of the smart of ID card 502 used, the identification of the shelf device 404, the transaction identification, the time and date data, the redemption status of any coupons, the value of any coupon and the applicable product UPC data.

FIG. 8 portrays a customer process of redeeming an electron coupon. After shopping, in 802, the customer reaches the POS terminal 606. In 804 the customer locates a redemption device 504 in proximity to the POS terminal 606. The smart or ID card 502 is passed by the redemption device 504 in 806. The redemption device 504 recognizes the smart card 502 in 806 and retrieves the electronic coupon from the smart card 502 in step 810 or in the case of an ID card 502 retrieves electronic coupon from the DB 810. The redemption device 504 retrieves the smart or ID card's 502 identification in step 812 and sends the coupon UPC data to a POS terminal 606, where the offer may be fully executed at checkout. It should be appreciated that if the card identification was associated with a coupon offer and stored in a database (as opposed to directly loading a smart card with the electronic coupon) the coupon UPC data would not be retrieved from the card directly out via the database essentially reversing steps 810 and 812.

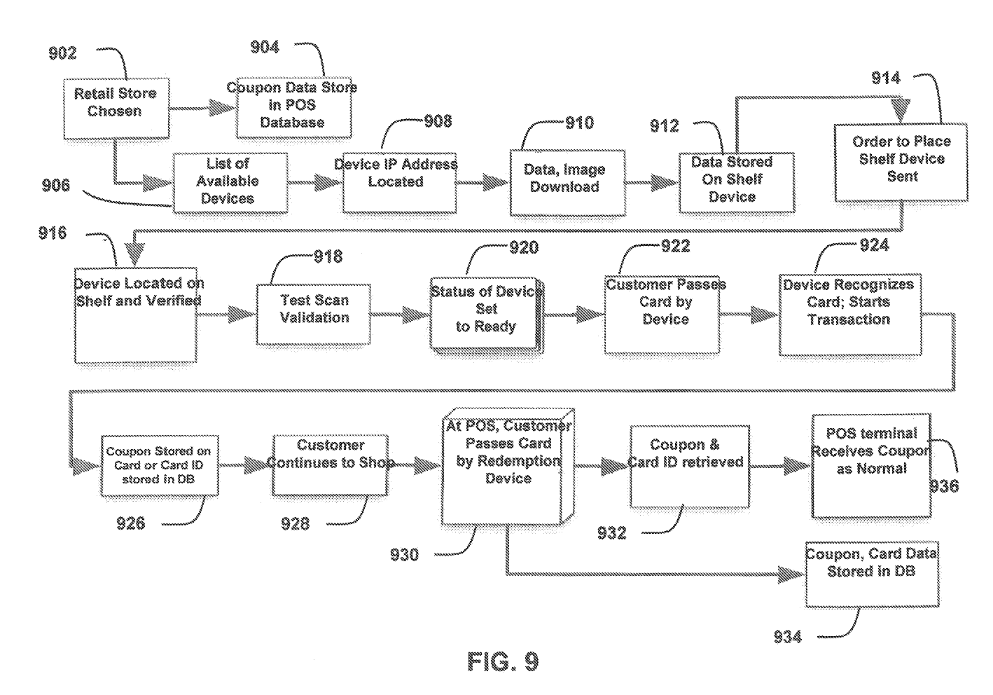

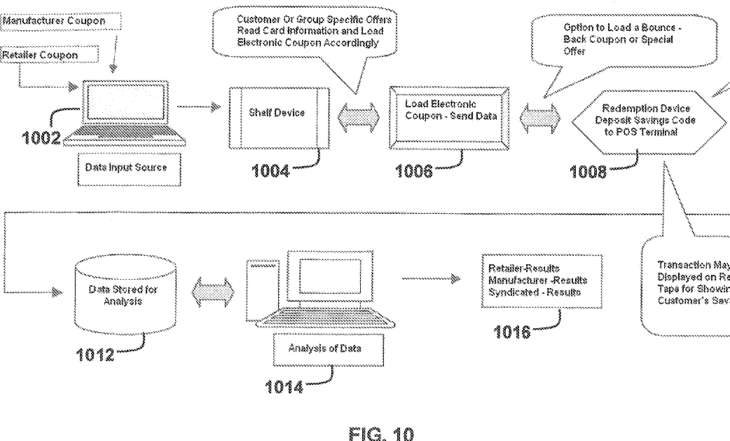

FIG. 9 displays a flow diagram that reaches the implementation of an efficient system and method of generating and redeeming an electronic coupon by a retail establishment. Block 902 shows a chosen retail store to which electronic coupons will be sent. Block 904 shows that the coupon data is downloaded to the POS terminals. The method of downloading this data can be ay number of methods as known in the art. A user is then shown a list of available shelf device in block 906. The specific device to be configured is selected by its IP address or other unique identifier in 908 and the coupon data and image data is downloaded to the device remotely in block 910. This data is stored 912 in the shelf device for transmission to a smart or ID card.

Block 814 displays transmitting an order in an appropriate retail employee to place the shelf device at a point within the retail establishment. In one embodiment the shelf device is placed near the item which is associated with the coupon data stored by the shelf device such that a shopping customer may use the shelf device with the coupon image displayed and be prompted to accept the coupon and purchase the product. In block 916, the device is located in the specified location and that location is verified. The verification of the location may be done manually, or through other means such as RFID. The shelf device next undergoes a rest scan validation process 918. Once the validation process is complete and the shelf device is validated the status of the system is set as ready 920.

A customer is now able to pass a smart or ID card by device for retrieving an electronic coupon 922. The device recognizes the smart or ID card and initiates a transaction 924. The coupon data is stored on the smart card 926 or in case of ID card 926 stored on DB 934. Transferring the electronic coupon to the smart card or transferring the ID from the ID card 926 to the device, may be accomplished wirelessly, by RF, IR communications or the like, or may be accomplished by contact via a magnetic stripe or barcode.

The customer continues to shop 928 and may retrieve a plurality of electronic coupons from a plurality of shelf devices. Once shopping is completed the customer locates a redemption device which may be located near a point of sale terminal and passes the smart or ID card by the redemption device in 930. Coupon and card data is retrieved from the start card or the DB 934 by the redemption device and transferred to a POS terminal in 932. In 934 the POS system processes the received coupon data as a normal coupon transaction.

A database is available for storing coupon requests based on a smart card or ID card transactions at shelf device, upon redemption that information is transferred to a redemption database. A second database is available for storing redemption data after the redemption device retrieves the coupon data and customer data from a smart card. This data may include the UP data of coupons retrieved, the identification of the smart or ID card used at the redemption device, the identification of the shelf device, the identification of the redemption device, the transaction identification, the time and date data, the redemption status of any coupons, the value of any coupons, the applicable product UPC data, and the POS terminal identification that was used to redeem any coupons.

The embodiment portrayed in FIG. 9 describes a shelf device which various advantageous. For example, the device described here is easy to install and requires little to no maintenance. In one embodiment the power supply for the device is a solar cell such that as long as the retail establishment is lit the shelf device may remain powered. Furthermore, the device is configured such that any power consumed is minimal. The device provides connectivity to an outside data source, such as a database and comprises internal memory for storing coupon data or smart card data. Either a paper label may be affixed to the shelf device to portray the item which shelf device and electronic coupon is associated, or an electronic display such as an LCD may be used.

The shelf device is configured to neatly fit into an already existing retail establishment structure such that implementing such a system will not be overly burdensome on a retailer. For example, in one embodiment the shelf device is configured to be approximately the size as shelf tags currently employed by retailers and known in the art. Furthermore, the devices lower repair time and cost by being configured to withstand shock and damage such as that delivered by being hit by a shopping cart or retail palette.

FIG. 10 portrays the data path of one embodiment of the novel disclosure. First, manufacturer or retailer specific coupons are transferred to a data input source 1002. The manufacturer and retailer coupons can be input directly to the data input source or stored in a database of many coupons.

The data input source may then be used to load the shelf device with appropriate coupon data including coupon UPC data at step 1004. This transmission may occur through various means of electronic communications such as via an Ethernet based network, wireless network, or other means as know in the art.

a smart or ID card is recognized by a shelf device which then transfers coupon data to the smart card or stores coupon request in DB and retrieves customer data from the smart card at step 1006. The smart or ID card may be recognized either through contact (magnetic stripe, bar code, etc.) or by means requiring no contact (wireless RF, IR communications, or wireless network). In one embodiment the shelf device is capable of establishing electronic coupons based on customer data. For example, a customer may be given a “reward coupon” for buying the same item several times over a specific time period. Other data may also be sent to the smart card including an option for a bounce-back coupon or special offer to be displayed to the customer at redemption.

The smart card then transfers data in a redemption device or in the case of an ID card, the ID is transferred to a process, which then transfers the UPC coupon data in a POS terminal at step 1008. The smart or ID card may be configured as a retailer loyalty program card. In another embodiment the redemption device is in communication with the retailer's loyalty program card database (not shown) such that when a smart card has transmitted all coupons to the redemption devices, the device may transmit appropriate data to the loyalty program card database. This may also be a process conducted by the Database when using an ID card.

The POS terminal then collects all coupon data and transmits the transaction details to a database at step 1010. It should be appreciated that transaction data associated (e.g. whether a coupon has been requested or redeemed) may be stored to a database prior to step 1010. Furthermore the POS terminal calculates the total savings to the customer based on the redeemed coupons. The POS terminal may also display the transaction activity on a display device, register tape or other means. The transaction activity shows the customer the benefits provided by the coupon.

The database transfers the stored data to a computer system in step 1012. A computer system then analyzes the stored data, creates, and transmits reports of the results to the retailer, the manufacturer, and a syndicate in steps 1014 and 1016 respectively. The analysis and reports are essential to increasing the efficiency of the overall coupon delivery and redemption system. Furthermore the reports provide data that may be used to more effectively target customers. Actions that may be taken by a manufacturer or retailer, based on the data presented in the reports are changing the coupon offer's value, modifying the coupon's time for redemption, moving the item to a different location in the retail establishment, or moving the coupon offer display of shelf device.

The generation, delivery, and redemption methods described herein can be implemented in various manners. The foregoing description of the preferred embodiments, therefore, is provided to enable any person skilled in the art to make or use the claimed subject matter. Various modifications to these embodiments will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein.

What is claimed is:

1. A method of generating and redeeming an electronic coupon, the method comprising the steps of:
generating an electronic coupon;
transferring an electronic coupon to a smart card;
use of an ID card to link an electronic coupons to a shopping event;
redeeming a electronic coupon at a retail location; and
tracking and analyzing user data of redeemed electronic coupons.

2. The method of claim 1 wherein the smart card is further capable of storing location data or time data.

3. The method of claim 2 further comprising the step of tracking the location of the smart card throughout the retail establishment, wherein the smart card further comprises an RFID tag.

4. The method of claim 3 wherein the smart or ID card transfers one of customer data, location data, time data, or coupon data for tracking and analysis to itself or a DB.

5. The method of claim 4 comprising the step of generating a new electronic coupon based on the tracking and analysis of consumer trend data.

6. The method of claim 2 wherein a shelf device transfers the electronic coupon to the smart card or to a DB record linked to consumer in the case of an ID card.

7. The method of claim 6 wherein the shelf device is capable of displaying coupon data.

8. The method of claim 1 wherein the electronic coupon is pre-loaded on the smart card or linked to an ID card.

9. The method of claim 1 wherein the electronic coupon is transferred to the smart card via the internet.

10. The method of claim 1 wherein the electronic coupon is transferred to the smart card or linked to an ID card at a kiosk.

11. The method of claim 10 wherein the kiosk is located at a retail store location.

12. A system for generating and redeeming an electronic coupon, the system comprising:
a computer system capable of executing instructions of a software product and having memory;
a database wherein the database is capable of storing electronic coupon and user data and is communication with the computer system;
a smart card capable of receiving an electronic coupon;
an ID card capable of linking electronic coupon data to a consumer;
a redemption device connected through the network to the database and capable of receiving an electronic coupon and user data; and
a software product wherein the software product is stored on a computer readable medium and capable of directing the computer system to perform the following actions:
instructing a computer system to generate an electronic coupon and store the electronic coupon in a database;
transferring an electronic coupon to a smart card;
transferring and linking an ID card to an electronic coupon;
instructing a computer system to redeem a coupon and analyze redemption data;
instructing a computer to display any results of the analysis.

13. The system of claim 12 further comprising a shelf device, wherein the shelf device is capable of transferring an electronic coupon to a smart card or retrieving an ID card identifier and storing with an electronic coupon.

14. The system of claim 13 wherein the shelf device further comprises a means for displaying coupon data.

15. The system of claim 14 wherein redemption data comprises one of at least customer data, location data or coupon data for tracking and analysis.

16. The system of claim 15 wherein a new coupon may be generated by the software product in accordance with the results of analysis.

17. The system of claim 12 further comprising a kiosk, wherein the kiosk is capable of transferring an electronic coupon to a smart card or linking to an ID card.

18. The system of claim 17 wherein the kiosk is located within a retail store location.

19. The system of claim 12 wherein the electronic coupon is preloaded onto a smart card.

20. The system of claim 12 wherein the electronic coupon is transferred to a smart card via the internet.
